(19) United States
(12) Patent Application Publication
(10) Pub. No.: US 2026/0351146 A1
(43) Pub. Date: Nov. 5, 2026

(54) ADVERTISING SIGN ASSEMBLIES AND METHODS OF USE

(71) Applicant: Maxwell Interstate, LLC, Cherry Hill, NJ (US)

(72) Inventor: Gerald J. Engle, Northfield, NJ (US)

(21) Appl. No.: 19/641,643

(22) Filed: Apr. 8, 2026

Related U.S. Application Data
(60) Provisional application No. 63/800,127, filed on May 5, 2025.

(51) Int. Cl. G09F 19/12; G09F 7/18

(52) U.S. Cl. CPC G09F 19/12; G09F 7/18; G09F 2007/1843

(57) ABSTRACT

A sign assembly and method of use for mounting on a structure, e.g., an outdoor building. The sign assembly includes a backing panel having one or more cut-out portions through which light can pass. The cut-out portions form an artistic background representing objects of a natural or fantasy world. Surrounding the backing panel is a frame having plural sections which serve to releasably hold peripheral edge portions of an advertising or promotional sheet over the backing panel when an advertising sheet is mounted on the assembly. The frame includes a portion which is removable to enable the advertising sheet to be inserted into the sign assembly and removed from the sign assembly. An optional cover sheet may also be provided to diffuse light passing through the backing panel.

### FIELD OF THE INVENTION

This invention relates generally to advertising signs and methods of use and more particularly to advertising signs and methods of use which enable the mounting of sheets of advertising or promotional material thereon when desired, and when not desired to provide aesthetically pleasing artistic background.

### CROSS-REFERENCE TO RELATED APPLICATIONS

This utility application claims the benefit under 35 U.S.C. §119(e) of Provisional Application Serial No. 63/800,127, filed May 5, 2025, entitled “Advertising Sign Assemblies And Methods Of Use”, the entire disclosure of that provisional application is incorporated by reference herein for all purposes.

### BACKGROUND OF THE INVENTION

One type of advertising signs commonly available is in the form of a planar backing panel having a peripheral edge located in a groove or slot of a metallic molding, such as an extruded aluminum or stainless-steel molding. The molding can either bent into a peripheral frame shape, e.g., a rectangular, square, or some other shape of the backing panel, or can be formed of plural extruded sections which are assembled together to match the peripheral contour of the backing panel by surrounding the peripheral edge of the backing panel. An advertising or promotional material sheet formed of thin plastic, paper or some other substrate and bearing advertising or promotional text and/or graphic materials printed thereon is typically configured to be releasably mounted on the sign by applying it over the backing panel so that the frame surrounds the periphery of the sheet. When it is desired to change the advertising or promotional sheet, the frame itself, or a portion of it, can be removed to provide access to the advertising sheet. That sheet can then be removed, whereupon a new and different advertising or promotional sheet can then be mounted on the backing panel.

While the foregoing prior art signs are suitable for their intended purpose, they leave something to be desired from the standpoint of aesthetics once the sheet of advertising or promotional material has been removed until a new replacement advertising sheet is mounted on the sign.

Thus, a need exists for an advertising sign which overcomes that drawback of the prior art. The subject invention addresses that need by providing an advertising sign assembly including an artistic backing panel which includes cut-out portions through which light can pass to establish an artistic background until a sheet of advertising material is placed on the backing panel.

### BRIEF SUMMARY OF THE INVENTION

One aspect of this invention is a sign assembly for use on a structure to releasably mount an advertisement sheet thereon. The sign assembly comprises a backing panel and a peripheral frame. The backing panel forms a back portion of the sign assembly. The backing panel has a plurality of cut-out portions enabling light to pass through the cut-out portions, whereupon the light passing through the cut-out portions forms an artistic background representing objects of a natural or fantasy world, such objects comprising scenery, architecture, flora, fauna, people, vehicles, everyday items, celestial bodies, and other identifiable forms. The peripheral frame comprises plural sections, one of the plural sections being removable. Each of the plural sections comprises a front surface, a rear surface, and an intermediate surface connecting the front surface to the rear surface. The intermediate surface forms an outer periphery of the peripheral frame. Esch of the plural sections includes a slot located between the front surface and the rear surface. The slot is located opposite the outer periphery of the peripheral frame. The peripheral frame is coupled to the backing panel, whereupon the artistic background can be seen by persons located in front of the sign assembly, with the peripheral frame surrounding the artistic background. The sign assembly is being configured for releasable mounting the advertisement sheet thereon. The advertisement sheet has a peripheral edge surrounding a front surface bearing advertising or promotional material thereon. The releasable mounting of the advertisement sheet is achieved by removing the one of the plural sections of the peripheral frame from the peripheral frame to expose lateral sides of the slots in other sections of the peripheral frame, whereupon the peripheral edge of the advertisement sheet can be slid into the exposed lateral sides of the slots so that the advertisement sheet overlies and obscures the artistic background. The one of the plural sections of the peripheral frame that had been removed is resecured to the peripheral frame to hold the advertisement sheet in place to enable it to be viewed from the front of the sign assembly.

In accordance with one preferred aspect of the sign assembly of this invention, the sign assembly additionally comprising a cover sheet having a peripheral edge surrounding a front surface. The cover sheet is translucent or transparent and configured for mounting in front of the backing panel on the sign assembly.

In accordance with another preferred aspect of the sign assembly of this invention, the cover sheet is mounted in front of the backing panel on the sign assembly by removing the one of the plural sections of the peripheral frame from the peripheral frame to expose the lateral sides of the slots in the other sections of the peripheral frame, whereupon the peripheral edge of the cover sheet can be slid into the exposed lateral sides of the slots so that the cover sheet overlies the artistic background. The one of the plural sections of the peripheral frame that had been removed is resecured to the peripheral frame to hold the cover sheet in place to enable light passing through the cut-out portions of the backing panel viewed through the cover sheet from the front of the sign assembly.

In accordance with another preferred aspect of the sign assembly of this invention, the backing panel is a rigid planar member.

In accordance with another preferred aspect of the sign assembly of this invention, the peripheral frame includes at least one aperture for receipt of a threaded securement component for mounting the sign assembly onto the structure.

In accordance with another preferred aspect of the sign assembly of this invention, the sign assembly additionally comprises at least one stand-off member configured to be interposed between the at least one aperture of the peripheral frame and a portion of the structure to mount the sign assembly on the structure.

Another aspect of this invention is a method of providing advertising or promotional material on a structure. The method comprises providing a sign assembly comprising a backing panel and a peripheral frame. The backing panel forms a back portion of the sign assembly. The backing panel has a plurality of cut-out portions forming an artistic background representing objects of a natural or fantasy world, such objects comprising scenery, architecture, flora, fauna, people, vehicles, everyday items, celestial bodies, and other identifiable forms. The peripheral frame comprises plural sections, one of the plural sections being removable. Each of the plural sections comprises a front surface, a rear surface, and an intermediate surface connecting the front surface to the rear surface. The intermediate surface forms an outer periphery of the peripheral frame. Each of the plural sections includes a slot located between the front surface and the rear surface. The slot is located opposite the outer periphery of the peripheral frame. The peripheral frame is coupled to the backing panel. The sign assembly is mounted on the structure whereupon light can pass through the cut-out portions to form the artistic background that can be seen by persons located in front of the sign assembly, with the peripheral frame surrounding the artistic background.

In accordance with one preferred aspect of the method of this invention, the method additionally comprises providing an advertisement sheet having a peripheral edge and a front surface. The advertisement sheet bears advertising or promotional material thereon. The one of the plural sections of the peripheral frame is removed from the peripheral frame to expose lateral sides of the slots in other sections of the peripheral frame. The peripheral edge of the advertisement sheet is slid into the exposed lateral sides of the slots so that the advertisement sheet overlies and obscures the artistic background. The one of the plural sections of the peripheral frame that had been removed to the peripheral frame is resecured to the peripheral frame to hold the advertisement sheet in place to enable it to be viewed from the front of the sign assembly.

In accordance with another preferred aspect of the method of this invention a cover sheet having a peripheral edge surrounding a front surface is provided. The cover sheet, which is translucent or transparent, is mounted in front of the backing panel on the sign assembly by removing the one of the plural sections of the peripheral frame from the peripheral frame to expose lateral sides of the slots in other sections of the peripheral frame. The peripheral edge of the cover sheet is slid into the exposed lateral sides of the slots so that the cover sheet overlies and obscures the artistic background. The one of the plural sections of the peripheral frame that had been removed to the peripheral frame is resecured to the peripheral frame to hold the cover sheet in place to enable light to pass through the cut-out portions and the cover sheet to form the artistic background that can be seen by persons located in front of the sign assembly, with the peripheral frame surrounding the artistic background.

In accordance with another preferred aspect of the method of this invention the peripheral frame includes at least one aperture, and wherein the method additionally comprises extending a threaded securement component through the at least one aperture and into a portion of the structure for mounting the sign assembly onto the structure.

In accordance with another preferred aspect of the method of this invention the method additionally comprises Interposing at least one stand-off member between the at least one aperture of the peripheral frame and the portion of the structure to mount the sign assembly on the structure.

### BRIEF DESCRIPTION OF SEVERAL VIEWS OF THE DRAWINGS

FIG. 1 is an illustration of an outdoor structure, e.g., a beach lifeguard stand, including a sign assembly constructed in accordance with one aspect of this invention mounted thereon, with the sign assembly bearing a sheet of advertising or promotional material mounted thereon.

FIG. 2 is an illustration, similar to FIG. 1, but showing the sign assembly without the sheet of advertising or promotional material, such as could be the case when no advertising is desired. In that condition the sign assembly nevertheless provides an aesthetically pleasing artistic background rather than an uninteresting or dull blank area.

FIG. 3 is a partially exploded isometric view of a peripheral frame portion or component of the sign assembly shown in FIGS. 1 and 2.

FIG. 4 is an isometric view of another portion or component, i.e., a backing or background panel, of the sign assembly shown in FIGS. 1 and 2.

FIG. 5 is an isometric view showing the portions of the sign assembly of FIGS. 3 and 4 assembled together.

FIG. 6 is an enlarged sectional view taken along lines 6 – 6 of FIG. 5.

FIG. 7 is a partially exploded isometric view of the sign assembly shown in FIG. 5 with a portion of the peripheral frame removed from the rest of the peripheral frame to enable a sheet of advertising or promotional material to be mounted in front of the backing panel of the sign assembly.

FIG. 8 is an isometric view of an exemplary sheet of advertising or promotional material that is shown in the completed sign assembly of FIG. 1.

FIG. 9 is an isometric view showing the portions of the sign assembly shown in FIGS. 7 and 8 assembled together.

FIG. 10 is an enlarged sectional view taken along lines 10 – 10 of FIG. 9.

FIG. 11 is an isometric view of another and optional portion or component, e.g., a cover panel, of an alternative embodiment of a sign assembly constructed in accordance with this invention.

FIG. 12 is a sectional view similar to FIG. 6 but showing the alternative sign assembly with the cover panel of FIG. 11 mounted over the backing panel of that sign assembly.

### DETAILED DESCRIPTION OF THE PREFERRED EMBODIMENTS OF THE INVENTION

In the following detailed description, reference is made to the accompanying drawings which form a part hereof, and in which are shown by way of illustration embodiments that may be practiced. It is to be understood that other embodiments may be utilized, and structural or logical changes may be made without departing from the scope. Therefore, the following detailed description is not to be taken in a limiting sense, and the scope of embodiments is defined by the appended claims and their equivalents. Various operations may be described as multiple discrete operations in turn, in a manner that may be helpful in understanding embodiments; however, the order of description should not be construed to imply that these operations are order dependent. The description may use perspective-based descriptions such as up/down, back/front, left/right, and top/bottom. Such descriptions are merely used to facilitate the discussion and are not intended to restrict the application of disclosed embodiments. The terms “coupled” and “connected,” along with their derivatives, may be used. These terms are not intended as synonyms for each other. Rather, embodiments “connected” may be used to indicate that two or more elements are in direct physical contact with each other. “Coupled” may mean that two or more elements are in direct physical contact. However, “coupled” may also mean that two or more elements are not in direct contact with each other yet still cooperate or interact with each other. For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element. The description may use the terms “embodiment” or “embodiments,” which may each refer to one or more of the same or different embodiments. Furthermore, the terms “comprising,” “including,” “having,” and the like, as used with respect to embodiments, are synonymous.

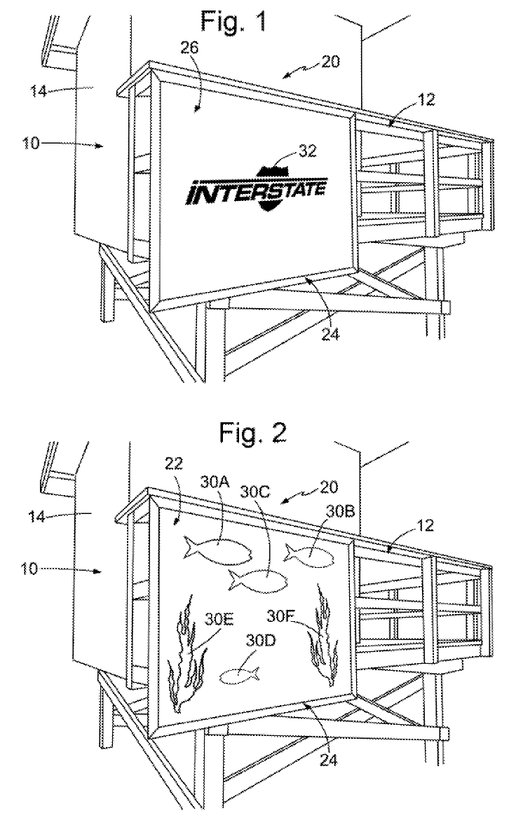

Referring now to the various figures of the drawing wherein like reference characters refer to like parts, there is shown in FIG. 1 one exemplary embodiment of a sign assembly 20 constructed in accordance with this invention for mounting onto a structure, e.g., an outdoor building. In the exemplary view of FIG. 1, the building constitutes a lifeguard stand or station 10 such as found on a beach. The lifeguard station includes a deck protected by a surrounding fence 12. In this application the sign assembly 20 is mounted on the fence 12 but could be mounted on some other portion of the structure, e.g., a wall 14 of the building 10.

The sign assembly 20 of this invention is designed to be used in either of two modes. In the mode shown in FIG. 1, which can be referred to as the operative or advertising mode, the sign assembly includes a sheet bearing advertising or promotional indicia, e.g., text and/or graphics, to be seen by persons viewing the sign assembly. In the mode shown in FIG. 2, which can be referred to as the empty or background mode, the sign assembly does not include the sheet of advertising or promotional material, whereupon an artistic background provided by the backing panel is visible thereby enhancing the appearance of the structure 10.

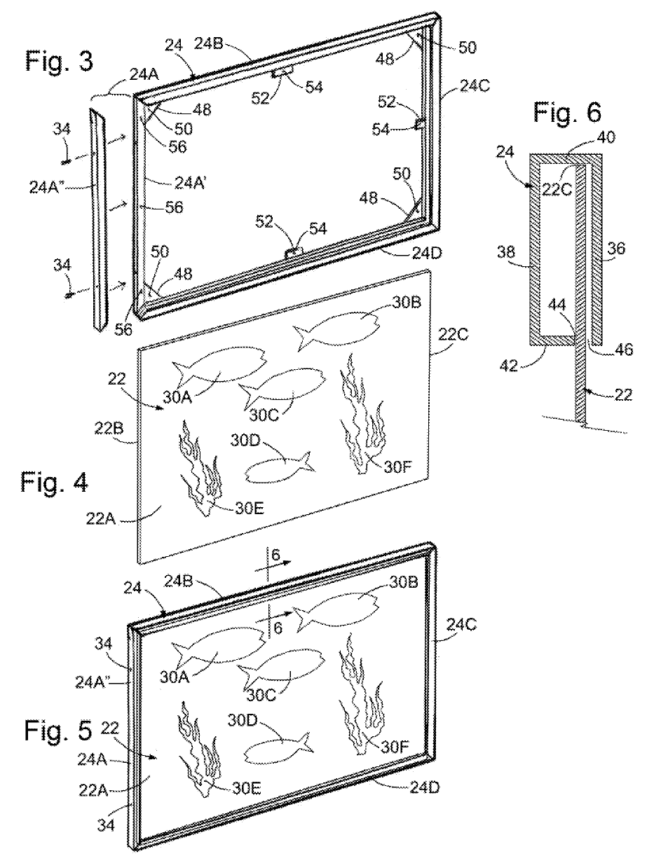

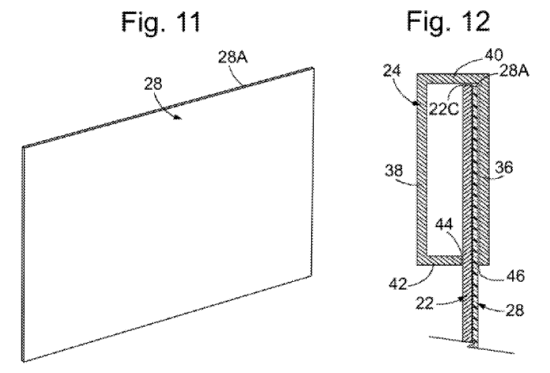

The components making up the sign assembly 20 are best seen in FIGS. 3, 4, and 8. Those components basically comprise a backing panel 22 (FIG. 4), a peripheral frame 24 (FIG. 3), and a sheet of advertising or promotional material 26 (FIG. 8). Optionally, the sign assembly 20 may also include a transparent or translucent cover panel 28 (FIG. 11).

The sign assembly 20 is of a regular geometric shape but can be of any desired shape. In the exemplary embodiment shown it is of a rectangular shape having a width of approximately 60 inches and a height of approximately 48 inches. The backing panel 22 is a generally planar member whose width and height are slightly less than the width and height of the sign assembly, since the backing panel is mounted within the confines of the sign assembly’s peripheral frame 24 as will be described later.

The backing panel 22 is formed of any strong, weather resistant material, e.g., aluminum particularly if the sign assembly is to be located outdoors in challenging weather conditions. Moreover, it can be of any suitable thickness, e.g., 2.03 mm, for structural integrity and to accommodate the weather conditions in the location at which the sign will be mounted. As best seen in FIG. 4 the backing panel 22 includes a front surface 22A, a rear surface 22B and a peripheral edge 22C.

In accordance with one important aspect of this invention the backing panel 22 includes one or more cut-out areas through which light can pass from the back surface to the front surface. The cut-out areas (also referred to as “cut-outs”) represent objects of a natural or fantasy world, e.g., any objects comprising scenery, architecture, flora, fauna, people, vehicles, everyday items, celestial bodies, and other identifiable forms. In the exemplary embodiment shown the objects are in the form of cut-outs shaped like fish 30A, 30B, 30C, and 30D, and cut-outs shaped like undersea vegetation, e.g., kelp 30E and 30F. Together the objects 30A - 30F, their size, arrangement, spacing and orientation form an artistic underwater scene. The cut-outs can be formed using any suitable technique, e.g., die-cutting, laser cutting, water-jet cutting, etc. Instead of utilizing a solid backing panel and cutting it to form the cut-out areas, the backing panel 22 with its cut-out areas can be formed as an integral molded part.

The advertising or promotional sheet 26 is a thin, e.g., 4 mm, member that is formed of any suitable material, e.g., plastic, paper, foil, and/or laminations thereof. It is of the same shape and size as the backing panel 22 and is configured to be disposed in front of the backing panel and held in place by portions of the frame 24, as will be described later. The advertising or promotional sheet 26 includes a front surface 26A, a rear surface 26B, and a peripheral edge 26C. The front surface bears any desired advertising or promotional text and or graphics printed thereon. In the exemplary embodiment shown the advertising or promotional material appearing on the front surface of the sheet 26 is in the form of text and graphics forming an “INTERSTATE” logo 34. It should be noted that the advertising or promotional text/graphics 32 can be printed on the front surface, or if the panel is formed of a transparent material can be printed on the rear surface to be visible on the front surface.

The frame 24 is best seen in FIG. 3 and includes four elongated linear frame sections 24A, 24B, 24C, and 24D which are fixedly secured, e.g., welded together at their mitered corners to form a rectangular shaped frame. The frame forms the periphery or border of the sign assembly 24. In particular, the frame section 24A forms the left-side section of the frame 24. The frame section 24B forms the top-side section of the frame 24. The frame section 24C forms the right-side section of the frame 24. The frame section 24D forms the bottom-side section of the frame 24. The left-side frame section 24A is itself made up of two portions, namely a rear portion 24A’ which is fixedly secured to the frame sections 24B and 24D, and a front portion 24A”. The front portion 24A” is configured to be releasably secured to the rear portion 24A’ by plural threaded fasteners, e.g., self-tapping screws 34. The front portion 24A”, being releasably securable to the rest of the frame 24, enables the front portion 24A” to be removed from the rest of the frame so that the sheet 26 bearing the advertising or promotional material can be introduced into the frame and disposed over the backing panel 22 when the sign assembly is fully assembled as will be described later to result in a sign like shown in FIG. 2.

Turning now to FIG. 6 it can be seen that once the frame 24 is fully assembled each of its elongated sections 24A – 24D is of the same generally rectangular cross-sectional shape. In particular each frame section includes a planar front wall 36 having an exterior surface, a planar rear wall 38 having an interior surface, an outer wall 40 having outer peripheral surface, and an inner wall 42 having an inner peripheral surface. The outer wall 38 connects the front wall 36 to the rear wall 38. The inner wall 42 is in the form of a flange projecting towards the front wall but having a free edge 44 spaced from the front wall 36 to form a slot or gap 46. It is in the slot or gap 46 of each frame section that the corresponding peripheral edge 22C of the backing panel 22 is disposed when the backing panel 22 is mounted in the sign assembly 20.

As best seen in FIG. 3 a triangularly shaped reinforcing plate 48 is fixedly secured, e.g., welded, at the rear surface at each mitered corner of the peripheral frame 24. Those plates ensure that the peripheral frame maintains its desired rectangular shape irrespective of wind other weather conditions. Each of the reinforcing plates 48 includes an aperture or hole 50 or receipt of a threaded fastener (not shown) to mount the sign assembly onto the desired structure, e.g., the fence 12. In addition to the reinforcing plates 48, the peripheral frame sections 24B, 24C and 24D each includes a flanged tab 52 extending flush with the back wall 38 of that frame section at approximately the middle of each frame section. Each tab 52 includes an aperture or hole 54 for receipt of a threaded fastener (not shown) to mount the sign assembly onto the desired structure. If desired or necessary, the sign assembly may make use of plural stand-offs (not shown) in the form of blocks of wood or other material for interposition between the reinforcing plates 48 and structure on which the sign assembly is to be mounted and foe interposition between the flange tabs 52 and the structure on which the sign assembly is to be mounted. Each such stand-off includes a bore extending through it through for receipt of the threaded fastener used to secure the peripheral frame to the fence or other structure on which the sign assembly is mounted.

Turning back to FIG. 1, the sign assembly 20 is shown in its empty state or mode in which it does not include any sheet 26 of advertising or promotional material. In that state or mode, the backing panel 22 is fully exposed so that light can pass through the various cut-outs in the backing panel, thereby enabling persons viewing the sign from the front of it to see the artistic underwater aquatic scene, rather than merely a solid plain or uniformly lit background. Accordingly, when the sign assembly in its empty mode it artwork background and enhances the appearance of the lifeguard station rather than detracting from its appearance.

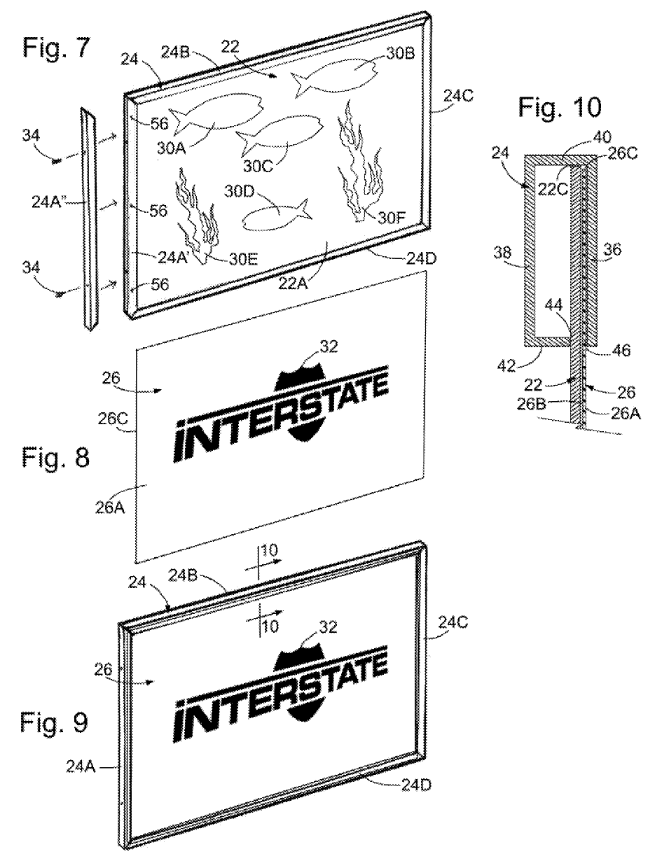

When it is desired to include advertising or promotional material in the sign assembly 20, all that is required is to remove the screws 32 so that the left-side section 24A” can be removed to the state shown in FIG. 7. Then a sheet 26, like that shown in FIG. 8, can be juxtaposed with respect to the frame 24 so that the top portion of the peripheral edge 26C of the sheet 26 can be slid into the slot 42 in the top section 24B of the frame and the bottom portion of the peripheral edge 26C of the sheet 26 can be slid into the slot 42 in the bottom section 24D. From there the sheet 26 can be slid to the right until the right-side portion of its peripheral edge 26C enters into the slot 42 in the right-side section 24C of the frame. At this time the advertising sheet 26 will be full disposed over the backing panel 22, like shown in FIG. 10 and held in place by the sections 24A – 24D of the frame, with the front surface 34 of those sections forming a border around the sheet 26, like shown in FIGS. 2 and 9.

The securement of the backing panel 22 with the advertising sheet 26 disposed thereover within the peripheral frame 24 can be accomplished by the use of threaded fasteners or screws (not shown) extending through the front wall 36 of each peripheral frame section through the interposed portions of the advertising sheet 26 and the backing panel 22 into holes 56 (FIGS. 3 and 7) in the frame sections. Once so assembled, the sign assembly 20 can then remain in that fully assembled state as long as desired to provide the advertising or promotional material.

When it is desired to change the advertising sheet 26 to another advertising sheet or merely to remove the advertising sheet 26 to expose the background scene of the backing sheet, all that is required is to remove the various screws. That action enables the frame section 24A” to be removed from the remainder of the frame so that the advertising sheet 26 can be slid out of the rest of the frame, whereupon the frame section 24A” can be resecured to the rest of the frame like shown in FIGS. 2 and 5.

As mentioned earlier the sign assembly 20 may include an optional cover panel 28 to result in an alternative sign assembly to the sign assembly 20 described heretofore. That exemplary alternative sign assembly will be of the same construction as the sign assembly 20, except that it will make use of the optional cover panel 28. One exemplary embodiment of the optional cover panel is shown in FIG. 11. As can be seen the cover panel is a thin, e.g., 2.03 mm thick, panel of the same basic size and shape as the backing panel 22 and having a peripheral edge 28A. The cover panel 28 is configured to be disposed in front of the backing panel 22 and is preferably formed of some transparent or translucent material, e.g., plastic, tempered glass, etc. Accordingly, when the cover panel 28 is disposed over the backing panel 22 light can pass through the cut-outs of the backing panel and through the cover panel to soften or blur the light passing through those cut-outs. That action can enhance the artistic appearance of the background scene produced by the backing panel. If desired, the cover panel may be colored of any desired color or colors to further enhance the visual appearance of the sign assembly when no advertising sheet is in place in the sign assembly. The cover panel 28, when used, is held in place over the backing panel by virtue of the peripheral edges of the cover panel being located within the slot 42 of the frame 24, like shown in FIG. 12, and with the screws like that described above with respect to the mounting of the backing panel 22 and advertising sheet 26 within the peripheral frame 24.

It should be appreciated by those skilled in the art, that while the sign assembly 20 of the subject invention is shown and described for mounting on an outdoor structure, such as a lifeguard stand, it can be mounted on any type of structure, whether indoors or outdoors. Moreover, various changes can be made to the structure of the system and its methods of use, other than those specifically described or disclosed above. For example, the materials making up the components of the peripheral frame, their shapes and sizes can be different than those disclosed above. Moreover, the methods of using such signs can be different than those disclosed above.

Without further elaboration the foregoing will so fully illustrate my invention that others may, by applying current or future knowledge, adopt the same for use under various conditions of service.

I claim:

1. A sign assembly for use on a structure to releasably mount an advertisement sheet thereon said sign assembly comprising:
a backing panel forming a back portion of said sign assembly, said backing panel having a plurality of cut-out portions enabling light to pass through said cut-out portions whereupon said light passing through said cut-out portions forms an artistic background representing objects of a natural or fantasy world, such objects comprising scenery, architecture, flora, fauna, people, vehicles, everyday items, celestial bodies, and other identifiable forms;
a peripheral frame comprising plural sections, one of said plural sections being removable, each of said plural sections comprising a front surface, a rear surface, and an intermediate surface connecting said front surface to said rear surface, said intermediate surface forming an outer periphery of said peripheral frame, each of said plural sections including a slot located between said front surface and said rear surface, said slot being located opposite said outer periphery of said peripheral frame, said peripheral frame being coupled to said backing panel, whereupon said artistic background can be seen by persons located in front of said sign assembly, with said peripheral frame surrounding said artistic background;
said sign assembly being configured for releasable mounting the advertisement sheet thereon, the advertisement sheet having a peripheral edge surrounding a front surface bearing advertising or promotional material thereon, the releasable mounting of said advertisement sheet being achieved by removing said one of said plural sections of said peripheral frame from said peripheral frame to expose lateral sides of said slots in other sections of said peripheral frame, whereupon the peripheral edge of the advertisement sheet can be slid into said exposed lateral sides of said slots so that the advertisement sheet overlies and obscures said artistic background, whereupon the one of said plural sections of said peripheral frame that had been removed is resecured to said peripheral frame to hold the advertisement sheet in place to enable it to be viewed from the front of said sign assembly.

2. The sign assembly of claim 1, additionally comprising a cover sheet having a peripheral edge surrounding a front surface, said cover sheet being translucent or transparent and configured for mounting in front of said backing panel on said sign assembly.

3. The sign assembly of claim 2, wherein said cover sheet is mounted in front of said backing panel on said sign assembly by removing said one of said plural sections of said peripheral frame from said peripheral frame to expose said lateral sides of said slots in said other sections of said peripheral frame, whereupon said peripheral edge of said cover sheet can be slid into said exposed lateral sides of said slots so that said cover sheet overlies said artistic background, whereupon said one of said plural sections of said peripheral frame that had been removed is resecured to said peripheral frame to hold said cover sheet in place to enable light passing through said cut-out portions of said backing panel viewed through said cover sheet from the front of said sign assembly.

4. The sign assembly of claim 1, wherein said backing panel is a planar member.

5. The sign assembly of claim 4, wherein said backing panel is a rigid planar member.

6. The sign assembly of claim 2, wherein said backing panel is a planar member.

7. The sign assembly of claim 6, wherein said backing panel is a rigid planar member.

8. The sign assembly of claim 1, wherein said peripheral frame includes at least one aperture for receipt of a threaded securement component for mounting said sign assembly onto the structure.

9. The sign assembly of claim 8, additionally comprising at least one stand-off member configured to be interposed between said at least one aperture of said peripheral frame and a portion of the structure to mount said sign assembly on said structure.

10. A method of providing advertising or promotional material on a structure, said method comprising:
providing a sign assembly comprising a backing panel and a peripheral frame, said backing panel forming a back portion of said sign assembly, said backing panel having a plurality of cut-out portions forming an artistic background representing objects of a natural or fantasy world, such objects comprising scenery, architecture, flora, fauna, people, vehicles, everyday items, celestial bodies, and other identifiable forms, said peripheral frame comprising plural sections, one of said plural sections being removable, each of said plural sections comprising a front surface, a rear surface, and an intermediate surface connecting said front surface to said rear surface, said intermediate surface forming an outer periphery of said peripheral frame, each of said plural sections including a slot located between said front surface and said rear surface, said slot being located opposite said outer periphery of said peripheral frame, said peripheral frame being coupled to said backing panel; and
mounting said sign assembly on said structure whereupon light can pass through said cut-out portions to form said artistic background that can be seen by persons located in front of said sign assembly, with said peripheral frame surrounding said artistic background.

11. The method of claim 10, additionally comprising:
providing an advertisement sheet having a peripheral edge and a front surface, said advertisement sheet bearing advertising or promotional material thereon;
removing said one of said plural sections of said peripheral frame from said peripheral frame to expose lateral sides of said slots in other sections of said peripheral frame; and
sliding said peripheral edge of said advertisement sheet into said exposed lateral sides of said slots so that said advertisement sheet overlies and obscures said artistic background; and
resecuring said one of said plural sections of said peripheral frame that had been removed to said peripheral frame to hold the advertisement sheet in place to enable it to be viewed from the front of said sign assembly.

12. The method of claim 10, additionally comprising:
providing a cover sheet having a peripheral edge surrounding a front surface, said cover sheet being translucent or transparent and configured for mounting in front of said backing panel on said sign assembly;
removing said one of said plural sections of said peripheral frame from said peripheral frame to expose lateral sides of said slots in other sections of said peripheral frame;
sliding said peripheral edge of said cover sheet into said exposed lateral sides of said slots so that said cover sheet overlies and obscures said artistic background; and
resecuring said one of said plural sections of said peripheral frame that had been removed to said peripheral frame to hold said cover sheet in place to enable light to pass through said cut-out portions and said cover sheet to form said artistic background that can be seen by persons located in front of said sign assembly, with said peripheral frame surrounding said artistic background.

13. The method of claim 11, additionally comprising:
providing a cover sheet having a peripheral edge surrounding a front surface, said cover sheet being translucent or transparent and configured for mounting in front of said backing panel on said sign assembly;
removing said one of said plural sections of said peripheral frame from said peripheral frame to expose lateral sides of said slots in other sections of said peripheral frame;
sliding said peripheral edge of said cover sheet into said exposed lateral sides of said slots so that said cover sheet overlies and obscures said artistic background; and
resecuring said one of said plural sections of said peripheral frame that had been removed to said peripheral frame to hold said cover sheet in place to enable light to pass through said cut-out portions and said cover sheet to form said artistic background that can be seen by persons located in front of said sign assembly, with said peripheral frame surrounding said artistic background.

14. The method of claim 10, wherein peripheral frame includes at least one aperture, and wherein said method additionally comprises extending a threaded securement component through said at least one aperture and into a portion of said structure for mounting said sign assembly onto said structure.

15. The method of claim 11, wherein peripheral frame includes at least one aperture, and wherein said method additionally comprises extending a threaded securement component through said at least one aperture and into a portion of said structure for mounting said sign assembly onto said structure.

16. The method of claim 14, additionally comprising interposing at least one stand-off member between said at least one aperture of said peripheral frame and said portion of the structure to mount said sign assembly on said structure.

17. The method of claim 15, additionally comprising interposing at least one stand-off member between said at least one aperture of said peripheral frame and said portion of the structure to mount said sign assembly on said structure.
